(19) United States
(12) Patent Application Publication
(10) Pub. No.: US 2006/0255657 A1
(43) Pub. Date: Nov. 16, 2006

(54) High pressure fluid system inlet throttle and method

(76) Inventors: William de Ojeda, Chicago, IL (US); Steven T. Omachi, Skokie, IL (US); Weiping Hu, Westmont, IL (US); Meixing Lu, Mukilteo, WA (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/129,171

(22) Filed: May 13, 2005

(51) Int. Cl. B60T 13/16

(52) U.S. Cl. 303/115.1; 303/10

(57) ABSTRACT

A high pressure fluid system (100) for an engine includes a high pressure reservoir (110) and a high pressure pump (116) fluidly connected to the high pressure reservoir (110). The high pressure pump (116) circulates fluid to the high pressure reservoir (110) and has and inlet throttle (114) arranged and constructed to control fluid flow rate at an inlet of the high pressure pump (116). A low pressure pump (102) is fluidly connected to the inlet throttle (114) and circulates the fluid from a low pressure reservoir (104) to the inlet throttle (114).

### FIELD OF THE INVENTION

This invention relates to fluid systems for internal combustion engines, including but not limited to high pressure fluid systems having a high pressure pump with an inlet throttle to supply fluid to injectors.

### BACKGROUND OF THE INVENTION

Some internal combustion engines have a fluid system to provide fuel or oil to various engine components. Engines typically compress and ignite a mixture of fuel and air in one or more cylinders. The ignited mixture generates rapidly expanding gases that actuate a piston. Each piston usually is connected to a crankshaft or similar device for converting an axial motion of the piston into rotational motion. The rotational motion from the crankshaft may be used to propel a vehicle, operate a pump or an electrical generator, or perform other work. The vehicle may be a truck, an automobile, a boat, or the like.

A typical fluid system includes a low pressure pump that circulates fluid from a sump or a low pressure reservoir to a high pressure pump. The high pressure pump circulates fluid to one or more high pressure reservoirs that supply fluid to injectors. Some hydraulic systems have an inlet throttle on an input side of the high pressure pump. The inlet throttle controls the flow of fluid into the high pressure pump. As the inlet throttle opens, more fluid flows to the high pressure pump. As the inlet throttle closes, less oil flows to the high pressure pump. The inlet throttle is typically biased to a fully open position. During operation, the biasing force of the inlet throttle is usually overcome by a hydraulic force that moves the inlet throttle into a more closed position. An injection pressure regulator on an outlet side of the high pressure pump usually shunts excess fluid back to the sump or low pressure reservoir under normal operating conditions.

Hydraulic feedback loops often generate instability in the operation of the high pressure pump. The instability generally occurs from throttling or reducing the flow of fluid into the high pressure pump when more flow is desired at the outlet of the high pressure pump. Lack of adequate pressure in the hydraulic feedback loop may not open the inlet throttle during engine startup and other operating conditions enough, causing fluid pressure at the outlet of the high pressure pump to be lower than desired. Moreover, many injection pressure regulators have multi-stage elements such as a main stage valve that can generate instability in the high pressure pump. The main stage valve usually is a mechanical pressure relief valve that opens when the fluid pressure is excessively high. The main stage valve discharges or shunts fluid to the sump to reduce the fluid pressure at the outlet of the high pressure pump to a desired pressure during normal operating conditions. The main stage valve can have a strong impact on pressure regulation by discharging a larger amount of fluid through a larger area than the pilot stage valve. The discharged fluid from the main stage valve may have little or no effect on the pressure of the fluid in the hydraulic feedback loop.

The hydraulic feedback loop control of the inlet throttle may be constrained by the physical limitations of a hydraulic-based system. The hydraulic feedback loop may be difficult to fine tune and may have time lags when implementing changes or quick adjustments to the position of the inlet throttle. The hydraulic feedback loop also may be affected by temperature changes and may increase the response time, i.e., the time needed for the inlet throttle to reach a high gain or fully open operation.

Accordingly, there is a need for control of an inlet throttle valve for a high pressure fluid pump that is stable, energy efficient, and has a quick response capability.

### SUMMARY OF THE INVENTION

A high pressure fluid system for an engine includes a high pressure reservoir fluidly connected to a high pressure pump. The high pressure pump circulates fluid to the high pressure reservoir and has an inlet throttle arranged and constructed to control a fluid flow rate at an inlet of the high pressure pump. A low pressure pump is fluidly connected to the inlet throttle and circulates the fluid from a low pressure reservoir to the inlet throttle.

An inlet throttle for a high pressure pump in a high pressure fluid system of an engine includes a core having a cylindrical bore and a spool valve disposed in the cylindrical bore. The spool valve includes a spool and a spring. The spring biases the spool in a fully open position and a solenoid is disposed on the core. The solenoid is arranged and constructed to move the spool in response to a drive signal.

A method includes the steps of circulating a fluid from a low pressure pump to an inlet throttle, controlling a fluid flow to a high pressure pump through the inlet throttle in response to a drive signal, circulating the fluid from the high pressure pump to a high pressure reservoir, and diverting a portion of the fluid flow when the fluid pressure at the outlet of the high pressure pump exceeds a maximum allowable pressure. The drive signal is responsive to a fluid pressure at an outlet of the high pressure pump.

### BRIEF DESCRIPTION OF THE DRAWINGS

FIG. 1 is a block diagram of a hydraulic fluid system for an engine in accordance with the invention.

FIG. 2 is a longitudinal, cross-section view of an inlet throttle in an open position disposed in a high pressure pump in accordance with the invention.

FIG. 3 is an expanded, perspective view of the inlet throttle of FIG. 2 in accordance with the invention.

FIG. 4 is a longitudinal, cross-section view of the inlet throttle of FIG. 2 in a closed position in accordance with the invention.

FIG. 5 is a graphical representation of stroke position versus surface area for the inlet throttle of FIG. 2 in accordance with the invention.

FIG. 5A through FIG. 5C are detail views of various spool positions for the inlet throttle of FIG. 2 in accordance with the invention.

FIG. 6 is a flowchart for a method in accordance with the invention.

### DESCRIPTION OF A PREFERRED EMBODIMENT

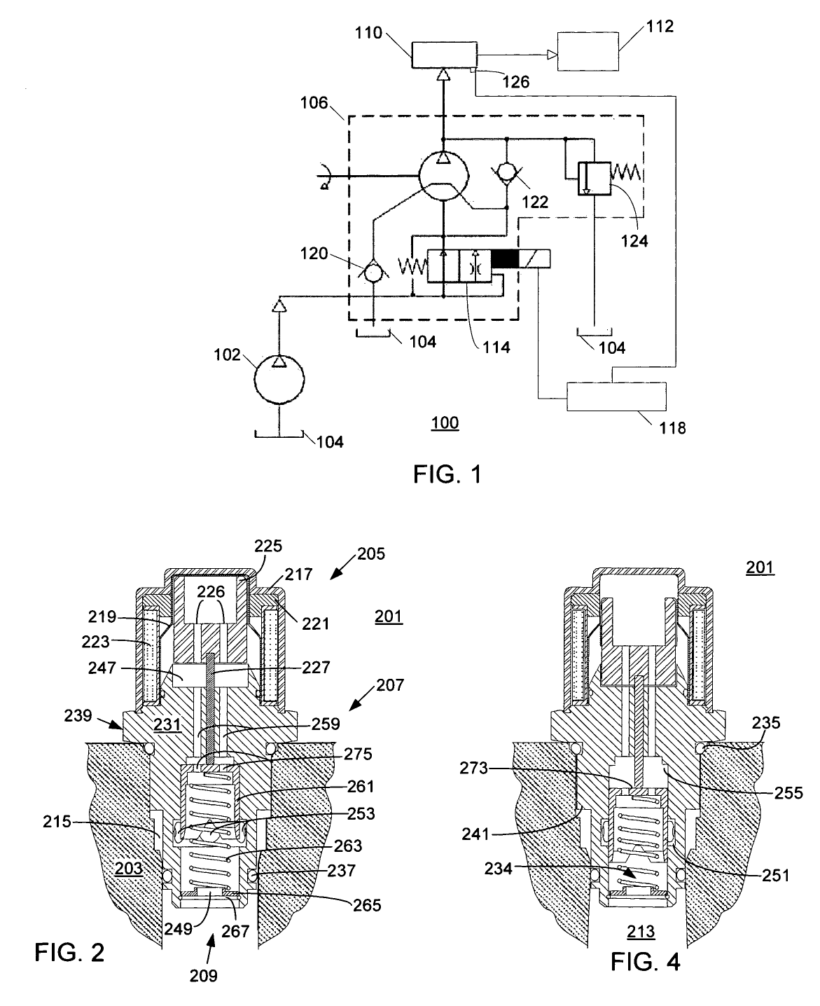

The following describes an apparatus for and method of directly controlling an inlet throttle placed on an inlet to a high pressure fluid pump of an internal combustion engine. A schematic diagram of a fluid system 100 for an internal combustion engine is shown in FIG. 1. The fluid system 100 has a low pressure pump 102 that circulates fluid from a reservoir 104 to a high pressure pump 106. The high pressure pump 106 circulates fluid to a high pressure reservoir 110 that supplies fluid to one or more injectors 112. Some engines may supply high pressure fuel to the injectors 112, while other engines may supply high pressure oil to the injectors 122. The high pressure pump 106 has an electrically actuated inlet throttle 114 that controls the flow of fluid from the low pressure pump 102 into the high pressure pump 116. The inlet throttle 114 has a spool valve that directly controls fluid flow and regulates fluid pressure at the outlet of the high pressure pump 116 in response to a command signal from an engine control module 118. A sensor may be arranged to sense fluid pressure at the outlet of the high pressure pump 106. A reading from the sensor may be relayed to the engine control module 118 for processing. While a particular configuration is shown, the fluid system 100 may have other configurations including those with additional components.

The high pressure pump 106 has a check valve 120, a ferry valve 122, and a relief valve 124. The check valve 120 may be the lip seals of the high pressure pump 116. The ferry valve 122 allows fluid to fill the high pressure reservoir 110 when the fluid cools and contracts after the engine shuts down. The relief valve 124 discharges fluid into the low pressure reservoir 104 when the pressure of fluid on the outlet side of the high pressure pump 116 becomes excessively high and exceeds a maximum allowable pressure. Under normal operating conditions, the relief valve 124 is expected to be closed and isolate fluid at a high pressure on the outlet of the high pressure pump 106 from fluid at a low pressure in the low pressure reservoir 104.

The engine control module 118 may have one or more microprocessors and electrical circuitry that monitor operation parameters of the engine. The engine control module 118 provides a command or drive signal to the inlet throttle 114 that is responsive to the fluid pressure in the high pressure fluid reservoir 110. The engine control module 118 monitors an electrical signal from the sensor, for example, an injection control pressure (ICP) sensor 126 located on the high pressure reservoir 110. The engine control module 118 may monitor the electrical signal continuously or intermittently such as with a sampling algorithm or the like. The electrical signal from the ICP sensor 126 is responsive to the fluid pressure in the high pressure reservoir 110. The fluid pressure in the high pressure reservoir 110 is expected to be substantially equal to or within 5% of the pressure at the outlet of the high pressure pump 116. The engine control module 118 may monitor other electrical signals from other sensors disposed at other locations of the engine, for instance sensors placed on the outlet side of the high pressure pump 116, or sensors placed at other locations on the engine. The drive signal may be responsive to other engine and vehicle operating parameters.

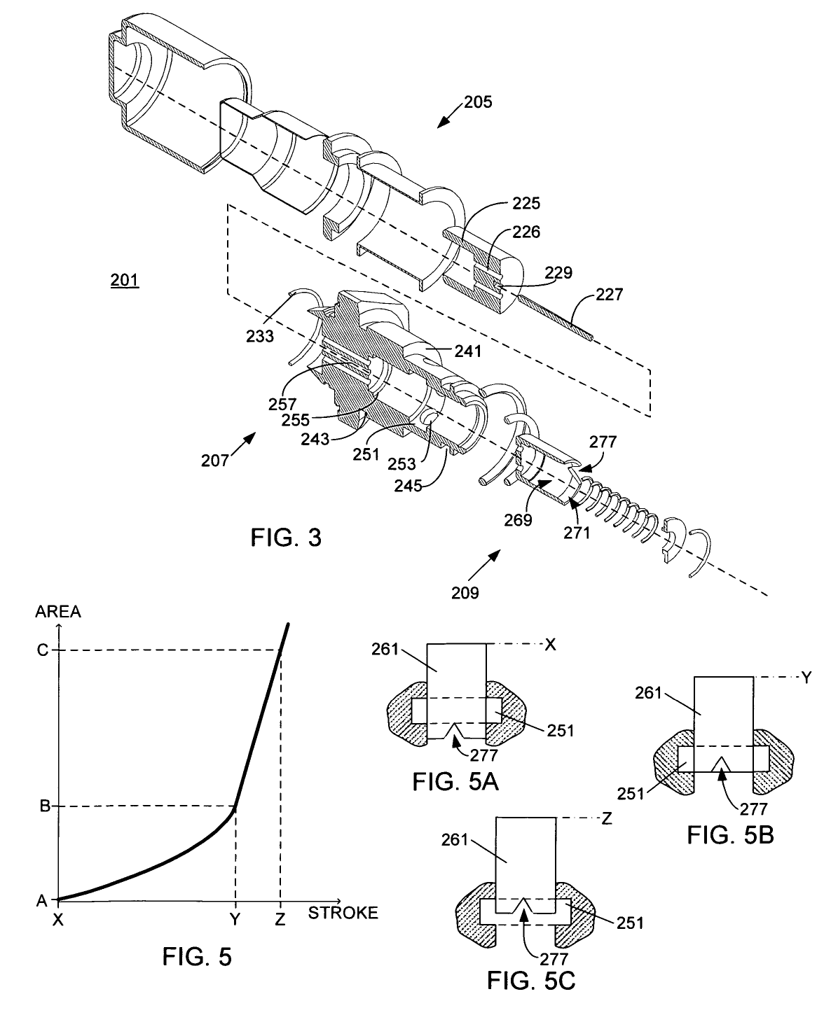

A longitudinal, cross-section view of an inlet throttle 201 disposed, for example, in a high pressure pump housing 203 is shown in FIG. 2, and an expanded, perspective view of the inlet throttle 201 of FIG. 2 is shown in FIG. 3. For the sake of clarity, some elements are not identified with leadlines and reference numerals in each of FIG. 2, FIG. 3, and FIG. 4. Although these elements are the same in each figure, they are identified in at least one of FIG. 2, FIG. 3 and FIG. 4.

The inlet throttle 201 has a solenoid 205, a valve assembly 207, and a spool assembly 209. The solenoid 205 is mounted on one end of the valve assembly 207. The spool assembly 209 is disposed in a cylindrical bore 211 formed in the other end of the valve assembly 207 as shown in FIG. 4. When assembled, the inlet throttle 201 is disposed in a pump bore 213 formed in a pump housing 203. The valve assembly 207 and the pump housing 203 form an entrance or supply chamber 215. While a particular configuration is shown, the inlet throttle 201 may have other configurations including those with additional components.

The solenoid 205 includes a solenoid housing 217, a bearing liner 219, a magnetic yoke 221, a bobbin 223, an armature 225 having passages 226, and a pin 227. The solenoid 205 also has electrical connections for connecting the solenoid 205 with an engine control module. The solenoid 205 may have other configurations. The solenoid housing 217 may be made from an electrically insulative material. The bearing liner 219 may be made from an electrically insulative and wear resistant material. The bobbin 223 is wound with a coil of electrically conductive material such as copper wire or the like. The coil may be wound on a substructure made of an electrically insulative material. The coil may advantageously be encased in an electrically insulative material. The armature 225 has a pin pocket 229. The pin pocket 229 is arranged along the axis of the armature 225. The armature 225 may be made from a magnetic material such as iron or the like. The pin 227 is cylindrical. The pin 227 has an outside diameter essentially the same as or less than the diameter of the pin pocket 229 in the armature 225. The pin 227 may be made of an electrically insulative material.

When the solenoid 205 is assembled, the magnetic yoke 221 is disposed in the solenoid housing 217. The bearing liner 219 is disposed in the solenoid housing 217 through the magnetic yoke 221 as shown. The bobbin 223 is disposed in the solenoid housing 217 adjacent to the bearing liner 219. The pin 227 is disposed in the pin pocket 229.

The valve assembly 207 has core 231, an first o-ring 233, a second o-ring 235, and a third o-ring 237. The core 231 has a flange section 239. The valve assembly 207 may be made from an electrically insulative material. The core 231 has a step 241 between a second circumferential groove 243 and a third circumferential groove 245 on its exterior surface. The core 231 has a cavity 247 opposite the flange section 239 and on the side of the solenoid 205. The step 241 is adjacent to the entrance chamber 215 when the inlet throttle 201 is disposed in the pump bore 213. The second o-ring 235 is disposed in the second circumferential groove 243. The third o-ring 237 is disposed in the third circumferential groove 245. The cylindrical bore 211 has an opening 249 opposite the cavity 247, and an interior circumferential channel 251 between the opening 249 and the flange section 239. One or more inlets or inlet holes 253 extend from the interior circumferential channel 251 to the step 241. The inlets 253 may be arranged equidistantly along the interior circumferential channel 251 and fluidly connect the opening 249 with the entrance chamber 215. The core 231 has a valve seat 255 in the cylindrical bore 211 near the flange section 239.

The flange section 239 has a pin passage 257 between the cylindrical bore 211 and the cylindrical cavity 247. The pin passage 257 extends essentially along the axis of the core 231. The pin passage 254 has a larger diameter than the pin 227. The flange section 239 forms one or more passages 259 between the cylindrical bore 211 and the cylindrical cavity 247.

The spool assembly 209 includes a spool 261, a spring 263, a retaining plate 265, and a retainer clip 267. The spool assembly 209 may be made of metal, plastic, a like material, or a combination thereof. The spool 261 forms a spool bore 269 with an opening 271 at one end and a spool base 273 at the other end. The spool base 273 has spool passages 275 that fluidly connect the spool bore 269 and the cylindrical bore 211. The spool 261 may advantageously form one or more gain notches 277 at the spool opening 271 as shown in FIG. 3. The gain notches 277 may have a triangular or other configuration. The retaining plate 265 has a larger cross section than the diameter of the spring 263. The retainer clip 267 may be a wire or like device. When assembled, the spring 263 is disposed on the retaining plate 265. The retainer clip 267 is used to hold the retaining plate 265 in the cylindrical bore 211 of the core 231 as is known in the art.

When the inlet throttle 201 is assembled, the solenoid 205 connected with the core 231 adjacent to the flange section 239. The first o-ring 233 engages and seals the bearing liner 219. The armature 225 is arranged and constructed to move in the cylindrical cavity 247. The pin 227 extends through the pin passage 257 in the flange section 239.

The spool assembly 209 is disposed in the cylindrical bore 211 of the core 231. The spool assembly 209 is disposed between the valve seat 255 and the interior circumferential groove 251 with the spool base 273 oriented toward the flange section 239. The spring 263 biases the spool 261 away from the retaining plate 265 and toward the valve seat 255.

During operation, the spool 261 advantageously moves within the cylindrical bore 211 and closes the interior circumferential channel 251 by partially or fully covering or blocking the interior circumferential channel 251. The inlet throttle 201 may position the spool 261 in a fully open position, a partially closed position, or a fully closed position in response to a drive or command signal from the engine control module 118. FIG. 2 is a longitudinal, cross-section view of the inlet throttle 201 with the spool 261 in a fully open position. FIG. 3 is an expanded, perspective view of the inlet throttle of FIG. 2 in accordance with the invention. FIG. 4 is a longitudinal, cross-section view of the inlet throttle 201 with the spool 261 in a fully closed position.

The inlet throttle 201 is in a fully open position when the spool 261 is adjacent to the valve seat 255. In the fully open position, the engine control module advantageously provides a weak or no drive signal to the solenoid 205. A drive signal is weak when it does not energize the solenoid 205 sufficiently to overcome the force of the spring 263 which biases the spool 261 toward the valve seat 255. The spool 261 pushes against the pin 227 and holds the armature 225 in position. The inlet throttle 201 is capable of providing fluid to the high pressure pump with little or no loss of pressure. The fluid flows from the low pressure pump into the entrance chamber 215. The fluid flows from the entrance chamber 215 through the inlets 253 and into the interior circumferential channel 251. The fluid flows from the interior circumferential channel 251, past the spool 261, the gain notches 277, and into the cylindrical bore 211. The fluid flows from the cylindrical bore 211, through the retainer 265, and out of the inlet throttle 210 to the high pressure pump through the opening 249. Some fluid may flow from the cylindrical bore 211 through the spool passages 275, the passages 259, and the armature passages 226 to lubricate the solenoid 205 and equalize the pressure on either side of the spool 261 to advantageously improve controllability and reduce response time.

The inlet throttle 201 is in a fully closed position when the spool 261 fully covers or blocks the interior circumferential channel 251 as shown in FIG. 4. The drive signal from the electronic control module energizes the solenoid 205 that moves the armature 225 into the cylindrical cavity 211 and against the core 231. The armature 225 pushes the pin 227 against the spool 261 and moves the spool 261 toward the opening 249 and into the position that fully blocks or covers the interior circumferential channel 251. In the fully closed position, the spool 261 essentially stops fluid flow from the interior circumferential channel 251 into the cylindrical bore 211 thus essentially stopping fluid flow into the high pressure pump. In the case where the fluid is oil, the spool 261 may permit a minimal amount of fluid to flow into the cylindrical bore 211 and thus the high pressure pump to, for example, lubricate the high pressure pump, offset potential system leakages, and the like.

The inlet throttle 210 is in a partially closed or partially open position when the spool 261 is between the fully open and fully closed positions. In a partially closed position, the spool 261 partially covers or blocks the interior circumferential channel 251. The drive signal from the electronic control module energizes the solenoid 205 to move the armature 225 at least partially into the cylindrical cavity 247. The armature 225 pushes the pin 227 against the spool 261, which moves the spool 261 toward the opening 249 and into the position that partially blocks or covers the interior circumferential channel 251. In the partially closed position, the spool 261 controls or throttles the fluid flow from the interior circumferential channel 251 into the cylindrical bore 211 thus reducing or restricting the fluid flow into the high pressure pump.

The gain notches 277 may be used to further control fluid flow through the inlet throttle 201. When the spool 261 moves from a fully closed to a partially closed or fully open position, the spool 261 uncovers the interior circumferential channel 251. Fluid flow from the interior circumferential channel 251 into the cylindrical bore 211 depends on the uncovered surface area of the interior circumferential channel 251. When the uncovered surface area increases, fluid flow increases. When the uncovered surface area decreases, fluid flow decreases. The uncovered surface area is determined by the stroke or position of the spool 261 in the cylindrical bore 211. Without the gain notches 277, the uncovered surface area changes uniformly as the stroke changes (i.e., the proportional change in the uncovered surface area may be linear as the spool 261 uncovers or covers the interior circumferential channel 251). With the gain notches 277, the uncovered surface area does not change uniformly as the stroke changes (i.e., the proportional change in the uncovered surface area is non-linear and varies as the spool 261 uncovers or covers the interior circumferential channel 251). The gain notches 277 may be configured to change the uncovered surface as required, for example, the rate of change of surface area versus stroke could exponential.

FIG. 5 is a graphical representation of an example for a relationship between the stroke position of the spool 261 represented on the horizontal axis, and the uncovered surface area of the interior circumferential channel 251 represented on the vertical axis. FIG. 5A through FIG. 5C section detail views of potential spool positions. If the spool 261 had no gain notches 277, the shape of a curve in the graph of FIG. 5 would be a straight line. The uncovered area of the interior circumferential groove 251 would be directly proportional to the stroke position of the spool 261. It is advantageous to skew the shape of a curve 500, as shown in FIG. 5, to deviate from a straight line over a segment of the curve 500 and match the dynamics of the engine with the dynamics of the high pressure fluid system.

The gain notches 277 skew the shape of the graph to deviate from a straight line, and may be appropriately shaped to provide other relationships between the stroke position of the spool 261 and the uncovered surface area of the interior circumferential channel 251. At stroke position X, the spool 261 is at a fully closed position, i.e., the solenoid 205 is fully extended and the spool 261 fully covers or blocks the interior circumferential channel 251 as shown in FIG. 5A. The corresponding uncovered surface area A at position X is close to zero. At stroke position Y, the spool 261 is at a partially closed position. The corresponding area B is essentially the maximum uncovered surface area of the circumferential channel 251 exposed by the gain notches 277, as shown in FIG. 5B. The stroke increases as the spool moves from the fully closed position of X to the partially closed position of Y. The uncovered surface area increases exponentially from A to B. The exponential trend of the surface area is attributed to the shape of the gain notches 277.

At stroke position Z, the spool 261 is at a fully open position as shown in FIG. 5C. The area C at position Z is essentially the maximum uncovered surface area exposed by the spool 261. The stroke increases as the spool 261 moves from the partially closed position of B to the fully open position of Z. The uncovered surface area increases linearly from B to C. The increased surface area C finds special advantage in a condition when the fluid is oil and the engine is at a low temperature. Increased viscosity of the oil at the low temperature may cause increased pressure drop in the flow. The increased surface area C may be adjusted to incur little to no pressure drop in the flow of oil through the inlet throttle.

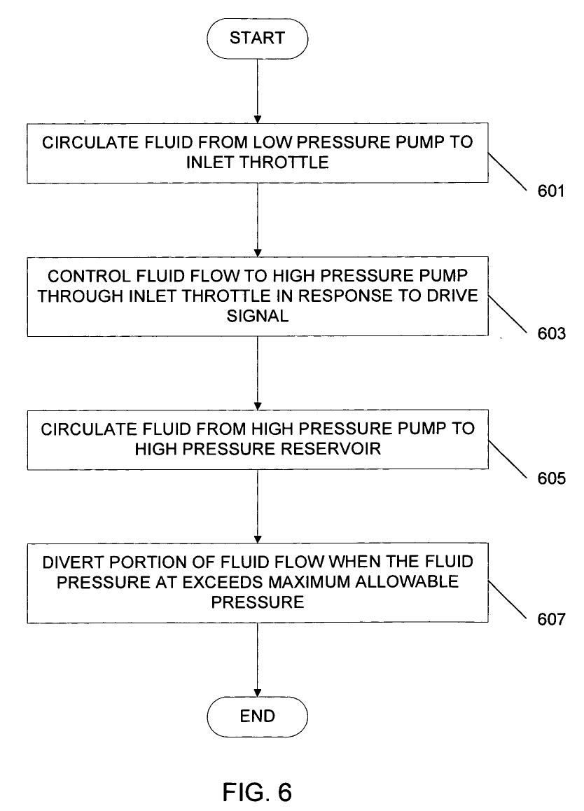

FIG. 6 is a flowchart for a method of controlling fluid flow and pressure of a high pressure pump in a fluid system of an engine. Fluid is circulated from a low pressure pump to an inlet throttle in step 601. Fluid flow from the inlet throttle to the high pressure pump is controlled in response to a pressure by a drive signal in step 603. The drive signal may be responsive to fluid pressure in a high pressure reservoir. The inlet throttle may adjust the fluid flow uniformly in response to the stroke or position of a spool in the spool valve. The inlet throttle may use a spool with gain notches to adjust the oil flow exponentially in response to the stroke or position of the spool. Fluid is circulated from the high pressure pump to a high pressure reservoir in step 605. Unlike typical systems in use, no fluid is shunted at the outlet of the high pressure pump to control the pressure of the fluid. A portion of the fluid flow at the outlet of the high pressure pump is advantageously only diverted in step 607 when the fluid pressure exceeds a maximum allowable value. The maximum allowable safe pressure value may be a maximum safe pressure for the fluid system, such as a pressure between about 5000 psi to about 5500 psi (about 34.5 Mpa to about 38 Mpa), below which the system is intended to operate, and above which the system is not intended to operate under any system operating condition. Most if not all fluid entering the high pressure pump is circulated to the high pressure reservoir under normal operating conditions.

One advantage of this invention is the elimination of a pressure control valve that typical systems use at the outlet of the high pressure pump to control fluid pressure at the high pressure pump outlet. The elimination of the pressure control valve also eliminates the typical shunting of high pressure fluid that effectively controls the pressure in traditional systems. Fluid entering the high pressure pump is pressurized and used in the high pressure reservoir, under normal operating conditions. Moreover, the response time and controllability of the high pressure fluid system is improved overall, thus improving overall system efficiency. The response time, i.e., the time lag between opening and closing the throttle valve, is reduced by the use of an electronic solenoid actuator. Typical systems -have relatively increased response times because the motive force of their inlet throttles is hydraulic pressure acting on a surface. The response time in traditional systems depends on the required to build hydraulic pressure. The response time for the inlet throttle of this embodiment does not depend on hydraulic pressure because the motive force for the inlet throttle is an electronic actuator. In one embodiment, the actuator is arranged to move the inlet throttle from an open to a closed position in about 150 ms.

An additional advantage of this embodiment is improved stability in the operation of the inlet throttle. With the pressure equalized on either side of the spool, the spool is balanced, the force required to move the spool is reduced, and additionally the spool is advantageously less prone to instability due to pressure fluctuations. A balanced spool configuration also permits low power consumption in the solenoid.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A high pressure fluid system for an engine, comprising:
a high pressure reservoir;
a high pressure pump fluidly connected to the high pressure reservoir, wherein the high pressure pump circulates fluid to the high pressure reservoir;
an inlet throttle connected to the high pressure pump, wherein the inlet throttle is arranged and constructed to control a fluid flow rate at an inlet of the high pressure pump;
a low pressure pump fluidly connected to the inlet throttle, wherein the low pressure pump circulates the fluid from a low pressure reservoir to the inlet throttle.

2. The high pressure fluid system of claim 1, further comprising:
a sensor disposed in fluid communication with the high pressure reservoir, wherein the sensor provides an electrical signal responsive to the fluid pressure in the high pressure reservoir;
an engine control module operably connected to the sensor and to the inlet throttle, wherein the engine control module provides a drive signal in response to the electrical signal; and
wherein the inlet throttle changes a position in response to the drive signal.

3. The high pressure fluid system of claim 2, wherein the sensor is disposed on the high pressure reservoir.

4. The high pressure fluid system of claim 1,
wherein the inlet throttle has a spool valve;
wherein the spool valve is arranged and constructed to control the fluid flow through the inlet throttle in response to a position of a spool in the spool valve.

5. The high pressure fluid system of claim 4, wherein the spool has at least one gain notch.

6. An inlet throttle for a high pressure pump in a high pressure fluid system of an engine comprising;
a core having a cylindrical bore;
a spool valve disposed in the cylindrical bore, wherein the spool valve includes a spool and a spring, wherein the spring biases the spool in a fully open position; and
a solenoid disposed on the core, wherein the solenoid is arranged and constructed to move the spool in response to a drive signal.

7. The inlet throttle of claim 6:
wherein the core forms an interior channel;
wherein the interior channel is in fluid communication with a supply chamber through at least one inlet hole;
wherein the solenoid is arranged and constructed to move the spool to fully cover the interior channel in response to the drive signal.

8. The inlet throttle of claim 6, wherein the spool has at least one notch.

9. The inlet throttle of claim 8, wherein the at least one notch is arranged and constructed to vary a relationship between a position of the spool and a flow area for fluid passing through the inlet throttle.

10. The inlet throttle of claim 9, wherein the at least one notch has a triangular configuration.

11. The inlet throttle of claim 6, further comprising:
a flange section disposed on the core, wherein the flange section forms a pin passage; and
a pin disposed in the pin passage, wherein the pin is disposed between a solenoid and the spool.

12. The inlet throttle of claim 11, wherein the flange section has flange passages, wherein the armature has armature passages, and wherein the spool has spool passages.

13. The inlet throttle of claim 12, wherein the pin base is fluidly communicating with the interior channel.

14. The inlet throttle of claim 11, wherein the solenoid is an electronic actuator.

15. A method comprising the steps of:
circulating a fluid from a low pressure pump to an inlet throttle;
controlling a fluid flow to a high pressure pump through the inlet throttle in response to a drive signal, wherein the drive signal is responsive to a fluid pressure at an outlet of the high pressure pump;
circulating the fluid from the high pressure pump to a high pressure reservoir; and
diverting a portion of the fluid flow when the fluid pressure at the outlet of the high pressure pump exceeds a maximum allowable pressure.

16. The method of claim 15, wherein the drive signal is responsive to the fluid pressure in the high pressure reservoir.

17. The method of claim 15, further comprising the steps of:
electromagnetically operating a spool in response to the drive signal; and
adjusting the fluid flow entering the high pressure pump in response to the position of the spool.

18. The method of claim 15, wherein is at least one of oil and fuel.

19. The method of claim 15, wherein the diverting step is accomplished by opening a pressure relief valve.

20. The method of claim 15, wherein the inlet throttle includes a spool, and wherein the spool is pressure balanced with respect to a fluid pressure.
